(19) United States
(12) Patent Application Publication
(10) Pub. No.: US 2011/0019177 A1
(43) Pub. Date: Jan. 27, 2011

(54) FIBER-OPTIC TRANSDUCER FOR FLUID AND/ OR GAS VELOCITY MEASUREMENT

(75) Inventors: Yan Kuhn De Chizelle, Sugarland, TX (US); Vladimir Vasilievich Tertychnyi, Edmonton (CA); Ivan Vladimirovich Nikolin, Moscow (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/377,636

(22) PCT Filed: Aug. 9, 2007
(86) PCT No.: PCT/RU07/00439

§ 371 Date: Oct. 11, 2010

(30) Foreign Application Priority Data
Aug. 16, 2006 (RU) 200612990

(51) Int. Cl. G01P 5/26

(52) U.S. Cl. 356/28.5

(57) ABSTRACT

This useful model relates to fiber-optic fluid/gas flow rate measurement transducers and is employed in gas/fluid flow measuring systems, and can be used for water or natural gas consumption monitoring, especially in measuring systems intended for fluid/gas flow monitoring in pipelines and oil/gas wells. The transducer includes optic fiber which comprises at least one Bragg's fiber lattice, wherein the said Bragg's fiber lattice is fitted with at least one concentrator of mechanical stresses which originate in the optic fiber during its interaction with the gas/fluid flow. As a result, the transducer sensitivity increases.

### FIELD OF ENGINEERING

This useful model relates to fiber-optic transducers for fluid/gas velocity measurement, which are applicable in fluid/gas flow measurement systems and can be used for water or natural gas consumption monitoring, especially in measuring systems which are intended for fluid/gas flow monitoring in pipelines and oil/gas wells.

### PRIOR ART

Fiber-optic transducers are known to be used as converters on a basis of lattices located along the optic fiber (light waveguide) (U.S. Pat. No. 6,271,766).

In the known device, each fiber-optic converter in the form of fiber-optic grid reflects different wavelength dependent on its spatial period. A wideband light signal from the light emitter spreads along the optical fiber and each converter reflects part of this signal in a certain wavelength band. Reflected waves enter a harmonic-wave analyzer. In particular, inter-fiber Bragg's lattices are employed as fiber-optic converters.

The known engineering solution is intended for monitoring of various electro-physical parameters in oil and gas well environment, i.e., media pressure and temperature, media flow vibration.

The deficiency of this device is that the fiber-optic transducer used in this device does not allow the monitoring of changes in the gas/fluid flow velocities.

A fiber-optic gas/fluid flow rate measurement transducer, which includes at least one Bragg's fiber lattice is the closest invention to the claimed model by its engineering essence (US 20050145039). The known engineering solution characterizes a fiber-optic transducer for fluid/gas flow rate measurement and includes optic fiber (fiber light waveguide) comprising Bragg's fiber lattices.

The deficiency of the known fiber-optic sensitivity to slight changes in controlled parameters.

### Useful Model Essence

This useful model aims to develop and produce a fiber-optic gas/fluid flow rate measurement transducer with improved performance data.

From engineering point of view, resolving of this task will allow the increase in the transducer sensitivity.

This engineering result is achieved by providing a Bragg's fiber lattice, which is used in the fiber-optic gas/fluid flow rate measurement transducer comprising at least one Bragg's fiber lattice, with a concentrator of mechanical stresses which originate in the optic fiber during its interaction with gas/fluid flow.

A distinguishing feature of this useful model is that a Bragg's fiber lattice is fitted with a concentrator of mechanical stresses which originate in the optic fiber during its interaction with gas/fluid flow. As a result, at slight changes in the gas/fluid flow rates mechanical stresses in the optic fiber and, consequently, in the Bragg's fiber lattice grow significantly, thus leading to a changed frequency of the reflected wave.

It's expedient to produce the mechanical stress concentrator in the form of an element whose cross sectional dimension is bigger as compared to the optic fiber diameter, which is placed near the Bragg's lattice.

It's expedient that the mechanical stress concentrator should be aerodynamically shaped, e.g., a sphere or ellipsoid.

It's expedient to place Bragg's fiber lattice in a protective enclosure which could be in a form of a hollow cylinder or tube.

Preferably, optic fiber should be fitted with a protective enclosure made of metal, carbon, ceramics, plastic, or polyamide.

### LIST OF DRAWINGS

FIG. 1 shows a fiber-optic gas/fluid flow rate measurement transducer arrangement, which was produced in compliance with this useful model;

FIG. 2 shows an option for fixation of optic fiber (light waveguide) and Bragg's fiber lattice in the enclosure.

### USEFUL MODEL IMPLEMENTATION

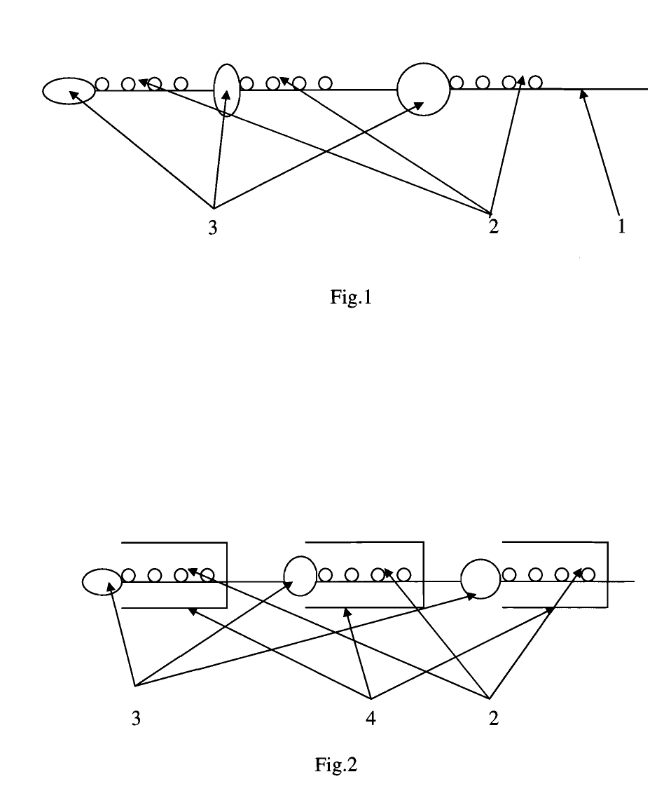

A fiber-optic gas/fluid flow rate measurement transducer shown in FIG. 1 includes optic fiber (light waveguide) (1), at least one Bragg's fiber lattice (2), and aerodynamically shaped mechanical stress concentrators (3).

As per FIG. 2, the fiber-optic gas/fluid flow rate measurement transducer is fitted with protective enclosures (4).

Optic fiber (1) with at least one Bragg's fiber lattice (2) in it is the basis of the transducer. Bragg's fiber lattice (2) is sensitive elements which are distributes along optic fiber (1) and which are affected by gas/fluid flow; as a result, mechanical stresses in the optic fiber (1) and Bragg's fiber lattice (2) are originated. In a steady state, i.e. at a constant flow rate of controlled gas/fluid, the periods of Bragg's fiber lattice (2) are stable. Mechanical stresses in Bragg's fiber lattice (2) are produced by friction forces emerging between a flowing fluid/gas and the optic fiber (1) located in the stream. The optic fiber (1) is fitted with a mechanical stress concentrator installed near Bragg's fiber lattice (2). As soon as gas/fluid flow rate changes, the spatial period of Bragg's fiber lattice (2) also changes, which, in its turn, changes the frequency of the reflected wave. The installation of the mechanical stress concentrator causes more notable changes in the spatial period of Bragg's fiber lattice. Signals reflected from Bragg's fiber lattice enter a receiver, e.g., a harmonic-wave analyzer.

In conformity with the suggested useful model, the transducer can be a part of the cable or a logging system that can be mounted in the pipeline either on a permanent basis, or when measurements are underway.

In conformity with the suggested useful model, the transducer can be manufactured by using any known method with the application of known technologies, and does not require special equipment or outfit.

1. A Fiber-optic gas/fluid flow rate measurement transducer comprising:
optic fiber containing at least one Bragg's fiber lattice, wherein the said Bragg's fiber lattice is fitted with a concentrator of mechanical stresses which originate in the optic fiber during its interaction with the gas/fluid flow.

2. The transducer of claim 1, wherein the mechanical stress concentrator is made in the form of an element whose cross-sectional dimension is bigger as compared to the optic fiber diameter, and which is placed near Bragg's lattice.

3. The transducer of claim 1, wherein the mechanical stress concentrator is aerodynamically shaped.

4. The transducer of claim 2, wherein the mechanical stress concentrator has a sphere or ellipsoid-like shape.

5. The transducer of claim 1, wherein Bragg's fiber lattice is placed into a protective enclosure.

6. The transducer of claim 5, wherein the protective enclosure is made as a hollow cylinder or a tube.

7. The transducer of claim 1, wherein optic fiber is furnished with a protective coating.

8. The transducer of claim 7, wherein the protective coating is made of metal.

9. The transducer of claim 7, wherein the protective coating is made of carbon.

10. The transducer of claim 7, wherein the protective coating is made of ceramics.

11. The transducer of claim 7, wherein the protective coating is made of plastic.

12. The transducer of claim 7, wherein the protective coating is made of polyamide.
